(19) United States
(12) Patent Application Publication
(10) Pub. No.: US 2010/0002078 A1
(43) Pub. Date: Jan. 7, 2010

(54) PERIPHERY MONITORING APPARATUS

(75) Inventor: Haruo Ito, Tokyo (JP)

Correspondence Address: ALPINE/BHGL, P.O. Box 10395, Chicago, IL, 60610, US

(73) Assignee: Alpine Electronics, Inc., Tokyo (JP)

(21) Appl. No.: 12/472,855

(22) Filed: May 27, 2009

(30) Foreign Application Priority Data
Jul. 3, 2008 (JP) 2008-174190

(51) Int. Cl. H04N 7/18

(52) U.S. Cl. 348/135; 348/E07.085

(57) ABSTRACT

A vehicle periphery monitoring apparatus detects a three-dimensional object or obstacle even through a vehicle is stopped. When is stopping or parking, a processor controls operation to store a bird's-eye image obtained by viewpoint conversion unit of a captured image, which is captured by a rear camera immediately before the vehicle parks or stops. Thereafter, the obstacle is detected based on a difference between image portions corresponding to a same captured region in a bird's-eye image of a captured image obtained for each time period, and in the stored bird's-eye image.

### PRIORITY CLAIM

This application claims the benefit of Japanese Patent Application No. 2008-174190, filed on Jul. 3, 2008, and which is incorporated by reference herein in its entirety.

### BACKGROUND

1. Field of the Invention

This disclosure relates to monitoring obstacles or other objects on the periphery of a vehicle.

2. Description of the Related Art

As a technique for monitoring obstacles near or about the periphery of a vehicle, a technique has been known in which changes in shape of a photograph subject, which are not caused by a difference between captured locations, are determined from multiple images of the periphery of the vehicle captured from different locations at different points in time while the vehicle is traveling, and a three-dimensional object existing on the periphery of the vehicle (for example, refer to Japanese Patent Application Publication 1998 (H10)-222679).

Further, there has been known a technique of capturing multiple images of the periphery of a vehicle with a plurality of cameras in such a manner that captured areas overlap, performing viewpoint conversion of each of the multiple images to thereby generate a plurality of bird's-eye images in which the periphery of the vehicle is viewed from above, and detecting a three-dimensional object on the periphery of the vehicle based on a difference between corresponding portions of the bird's-eye images representing the same captured area (for example, refer to Japanese Patent Application Publication 2006-339960).

According to the technique described in Japanese Patent Application Publication 2006-339960, the plurality of cameras are needed to detect the three-dimensional object on the periphery of the vehicle.

On the other hand, when the technique described in JP H10-222679 is applied to the technique described in JP 2006-339960, to capture while a vehicle is traveling, multiple images of the periphery of the vehicle on different locations at different points in time using a single camera, and viewpoint conversion of each of the multiple images is performed to generate a plurality of bird's-eye images in which the periphery of the vehicle is viewed from above. Detection of a three-dimensional object on the periphery of the vehicle based on a difference between corresponding portions of the generated plurality of bird's-eye images that represent the same captured area, and the object on the periphery of the vehicle can be detected using the single camera.

However, while the vehicle is stopping, because images of the periphery of the vehicle captured at different points in time are all captured on the same locations, the difference is not obtained from the images. Therefore, it is impossible to detect the three-dimensional object on the periphery of the vehicle using the single camera.

Therefore, it is desired to provide a periphery monitoring apparatus capable of detecting an obstacle which is a three-dimensional object on a periphery of a vehicle even when the vehicle is stopping.

### SUMMARY

With this in view, the present invention advantageously provides an on-vehicle periphery monitoring apparatus in which a camera for capturing a periphery of the vehicle, a traveling/not-traveling detection unit that detects whether the vehicle is traveling or stopping, an image storage unit in which when a stop of the vehicle is found, an image captured prior to the stop by the camera is stored as a pre-stop image, and an obstacle detection unit that detects, during a time period in which the traveling/not-traveling detection units is detecting that the vehicle is stopping, an obstacle on the periphery of the vehicle based on a difference between a current image captured by the camera and the pre-stop image stored in the image storage unit.

In the periphery monitoring apparatus as described above, the image of the periphery of the vehicle captured prior to the stop of the vehicle is stored as the pre-stop image at the time when the vehicle is stopped, to thereby detect the obstacle on the periphery of the vehicle based on the difference between the current image captured at each point in time and the pre-stop image stored in the image storage unit while the vehicle is stopping. Here, in the image of the periphery of the vehicle captured prior to the stop and stored as the pre-stop image, the periphery of the vehicle has been captured at a position which will be different from those where the images are to be captured while the vehicle is stopping. Therefore, in this manner, the obstacle which is the three-dimensional object on the periphery of the vehicle can be also detected while the vehicle is stopping.

Further, in the periphery monitoring apparatus, the obstacle detection unit may be configured to detect the obstacle on the periphery of the vehicle also based on a difference between the current image captured by the camera and an image captured prior to the current image in addition to the difference between the current image captured by the camera and the pre-stop image stored in the image storage unit during the time period in which the traveling/not-traveling detection unit detects that the vehicle is stopping.

In this configuration, an obstacle which is presently moving on the periphery of the vehicle can be detected. Still further, in the above-described periphery monitoring apparatus, the obstacle detection unit may be configured to detect the obstacle on the periphery of the vehicle based on the difference between the current image captured by the camera and the image captured prior to the current image by the camera during a time period in which the traveling/not-traveling detection unit detects that the vehicle is traveling.

With this configuration, in addition to the obstacle which is the three-dimensional object existing on the periphery of the vehicle, a movable object can be detected while the vehicle is traveling can be detected.

Moreover, detection of the obstacle in the above-described obstacle detection unit may be performed based on a bird's-eye image which is generated by viewpoint conversion of the image captured by the camera, so as to represent the periphery of the vehicle in a state observed from above.

More specifically, in this case, a viewpoint conversion unit, for example, that performs viewpoint conversion of the image captured by the camera to thereby generate the bird's-eye image representing the periphery of the vehicle in the state observed from above may be further provided. Then, when the stop of the vehicle is found, the bird's-eye image generated by the viewpoint conversion unit may be stored as the pre-stop image in the image storage unit, and, during the time period in which the traveling/not-traveling detection unit detects that the vehicle is stopping, the obstacle on the periphery of the vehicle may be detected in the obstacle detection unit based on a difference between image portions corresponding to the same captured region in a latest bird's-eye image generated by viewpoint conversion of the current image captured by the camera and in the pre-stop image stored in the image storage unit.

Further, in this case, during the time period in which the traveling/not-traveling detection unit detects that the vehicle is stopping, the obstacle on the periphery of the vehicle may be detected in the obstacle detection unit also based on a difference between the latest bird's-eye image and a bird's-eye image generated prior to the latest bird's eye image in addition to the difference between the image portions corresponding to the same captured region in the latest bird's-eye image and in the pre-stop image stored in the image storage unit.

Still further, while the vehicle is traveling, the obstacle on the periphery of the vehicle may be detected in the obstacle detection unit based on the difference between the latest bird's-eye image and the bird's-eye image generated prior to the latest bird's-eye image during a time period in which the traveling/not-traveling detection unit detects that the vehicle is traveling.

As described above, the periphery monitoring apparatus capable of detecting the obstacle being the three-dimensional object on the periphery of the vehicle even when the vehicle is stopped is provided according to the present invention.

### BRIEF DESCRIPTION OF THE DRAWINGS

FIG. 1a is a block diagram showing a configuration of a periphery monitoring system according to an embodiment of the present invention;

FIG. 1b is a pictorial view showing a vehicle and image capture geometry;

FIG. 2 is a flowchart showing a detection mode switching process according to a specific embodiment;

FIG. 3 is a diagram showing operation of the detection mode switching process according to a specific embodiment;

FIG. 4 is a diagram showing obstacle detection according to a specific embodiment; and

FIG. 5 is a diagram showing obstacle detection according to a specific embodiment.

### DETAILED DESCRIPTION

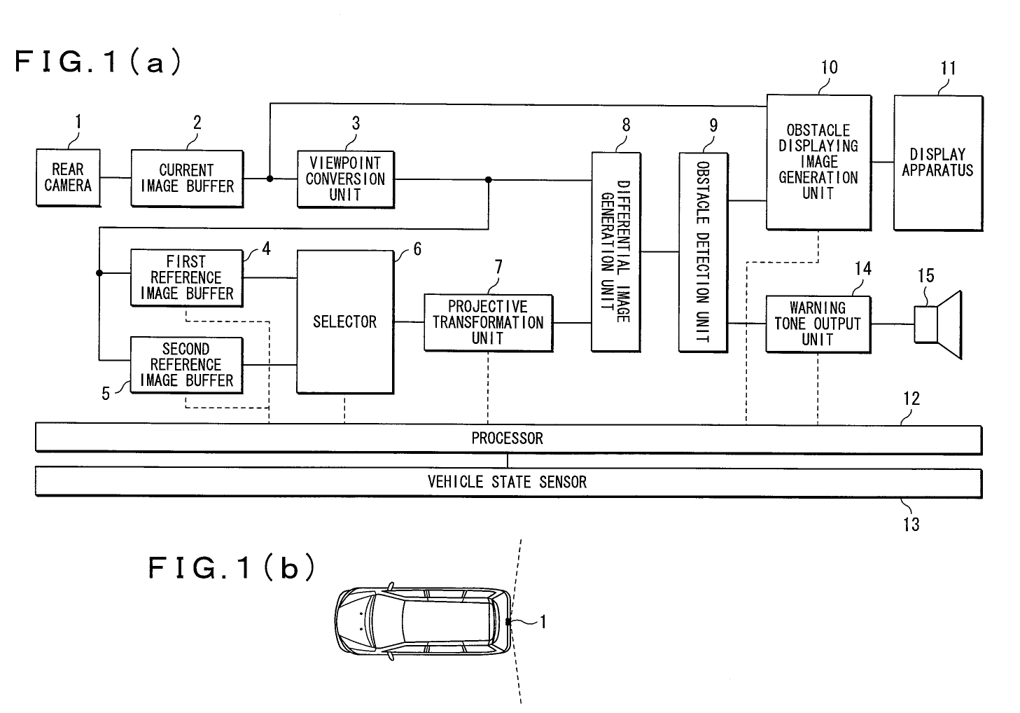

A preferred embodiment of the present invention will be described below. FIG. 1(a) shows a configuration of a periphery monitoring system. The periphery monitoring system is an on-vehicle system and includes a rear camera 1, a current image buffer 2, a viewpoint conversion unit 3, a first reference image buffer 4, a second reference image buffer 5, a selector 6, a projective transformation unit 7, a differential image generation unit 8, an obstacle detection unit 9, an obstacle displaying image generation unit 10, a display apparatus 11, a processor 12, a vehicle state sensor 13, a warning tone output unit 14, and a speaker 15.

The rear camera 1 is a wide angle camera installed in a posterior portion of a vehicle as shown in FIG. 1(b) to capture rearward facing images. Further, the vehicle state sensor 13 detects various states of the vehicle, such as a vehicle speed, a braking condition, parking brake condition, a steering angle, or an angular velocity.

The periphery monitoring system may be embodied in hardware using a computer equipped with a microprocessor, a memory, and other peripheral devices. Individual components of the peripheral monitoring system other than the rear camera 1 and the display apparatus 11 may be implemented in software such as by causing the microprocessor to execute a predetermined program.

Operation of such a vehicle-mounted monitoring system will be described.

The processor 12 determines, from the vehicle speed, the steering angle, or the angular velocity detected by the vehicle state sensor 13, an amount of change in position and orientation of the vehicle during each cycle of data collection or image pickup cycle.

The rear camera 1 captures an image of the rear of the vehicle and stores the image in the current image buffer 2 as a current captured image for each image pickup cycle. It is assumed that the rear camera 1 outputs, as the captured image, a mirror image in which a photographed subject is horizontally flipped. However, a camera which outputs as the captured image a normal image in which the subject is not horizontally flipped may be used as the rear camera 1.

The current image buffer 2 outputs the current captured image stored therein to both the viewpoint conversion unit 3 and the obstacle displaying image generation unit 10 for each image pickup cycle.

Then, the viewpoint conversion unit 3 performs view point conversion on the current captured image to generate a bird's-eye image showing the rear of the vehicle viewed from above as a current bird's-eye image. In addition to outputting the current bird's-eye image to the differential image generation unit 8, the viewpoint conversion unit 10 stores the current bird's-eye image as a delayed bird's-eye image in the first reference image buffer 4 or the second reference image buffer 5, which is set to a delayed image buffer.

The first reference image buffer 4 and the second reference image buffer 5 are alternately set to the delayed image buffer in a detection mode switching process (which will be described later) performed by the processor 12. Further, one of the reference image buffer 4 or 5 being set to the delayed image buffer is used for storing the delayed bird's-eye image for each image pickup cycle. In addition, the other of the first reference image buffer 4 or the second reference image buffer 5 which is not set to the delayed image buffer may be, in some cases, set to a fixed image buffer in the detection mode switching process. In this case, the first reference image buffer 4 or the second reference image buffer 5 being set to the fixed image buffer continuously retains, as a fixed bird's-eye image, the delayed bird's-eye image which has been stored at the time of the setting to the fixed image buffer for the duration of time the first or second reference image buffer is set as the fixed image buffer.

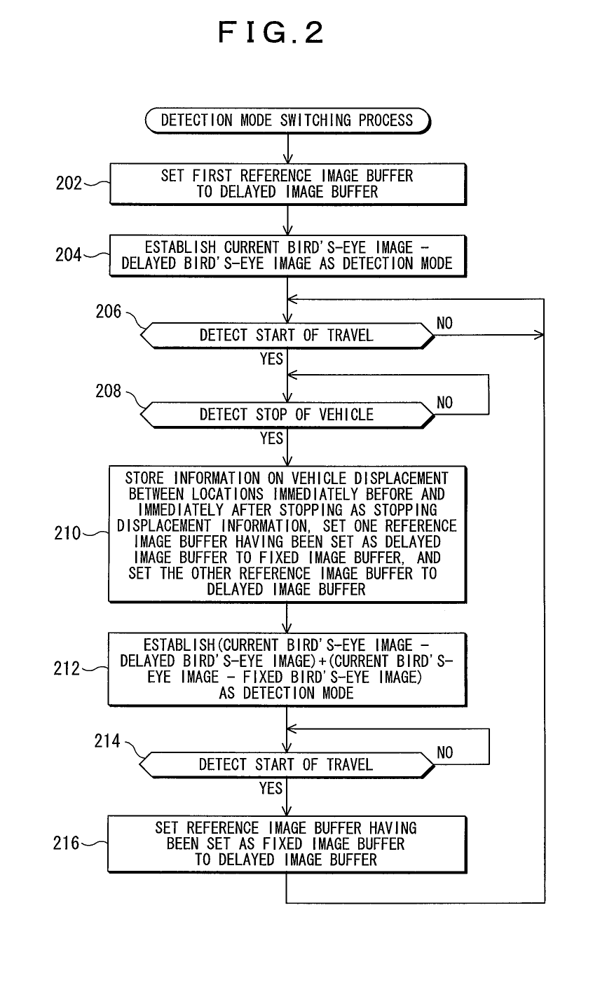

Now, the detection mode switching process for setting up the above-described delayed image buffer and the fixed image buffer will be described with reference to FIG. 2. In this process, the first reference image buffer 4 is initially specified to the delayed image buffer (Step 202), and a mode (current bird's-eye image−delayed bird's-eye image) is established as an obstacle detection mode (Step 204). The obstacle detection mode of (current bird's-eye image−delayed bird's-eye image) will be described in detail further below.

Next, start of vehicle travel is awaited until the start is determined based on the vehicle speed, the braking condition of the parking brake, or the like detected by the vehicle state sensor 13 (Step 206), and, after the vehicle travel is started, occurrence of parking or a stop of the vehicle is awaited (Step 208).

When the vehicle is parked or brought into a stop (Step 208), information on vehicle displacement representing an amount of change in a position and orientation of the vehicle from the image pickup cycle immediately before the vehicle stop to the image pickup cycle immediately after the vehicle stop determined upon detection of the vehicle stop is stored as stopping displacement information. Further, the first reference image buffer 4 or the second reference image buffer 5 which is presently set to the delayed image buffer is re-set to the fixed image buffer, while the other reference image buffers is set to the delayed image buffer (Step 210).

Moreover, a mode {(current bird's-eye image−delayed bird's-eye image)+(current bird's-eye image−fixed bird's-eye image)} is established as the obstacle detection mode (Step 212). Details of the obstacle detection mode of {(current bird's-eye image−delayed bird's-eye image)+(current bird's-eye image−fixed bird's-eye image)} will be described later.

Next, occurrence of a start of vehicle travel is awaited (Step 216). When the start of travel of the vehicle is detected, operation returns to Step 204 and repeats the process steps from Step 204.

Up to this point, the detection mode switching process performed by the processor 12 has been described.

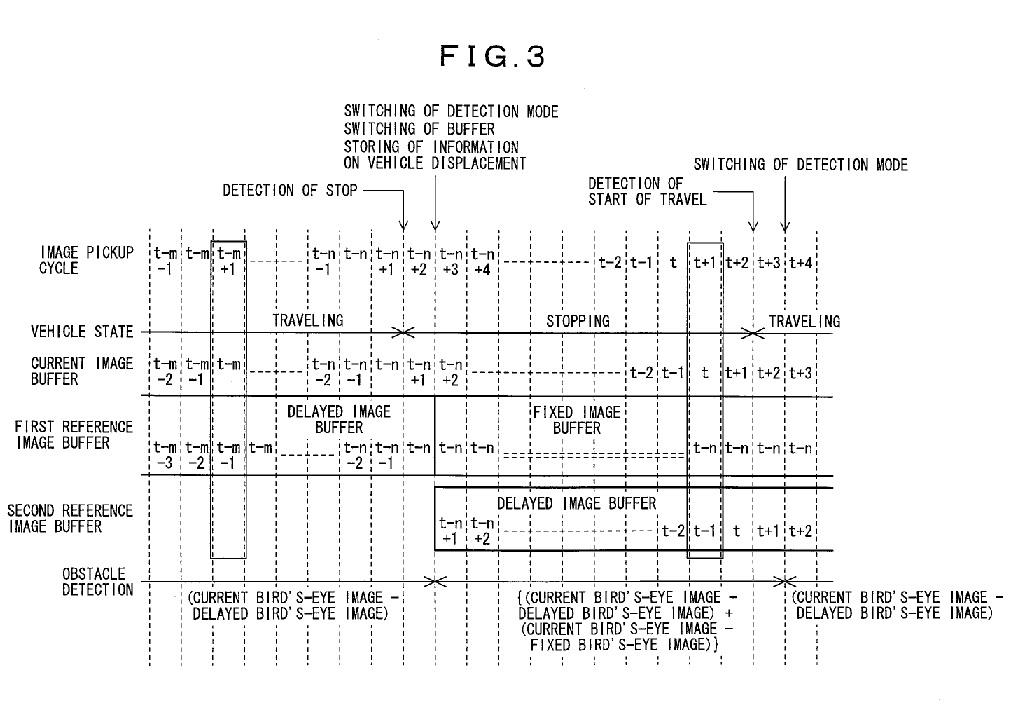

According to such switching detection processing, in a case where there are image pickup cycles from t−m−1 to t+4 in order of time as shown in FIG. 3, for example, settings of the delayed image buffer, the fixed image buffer, and the detection mode are established when a traveling vehicle is brought into a stop in a cycle t−n+1, and subsequently starts traveling again in a cycle t+2 as described below.

In this regard, it is assumed that the first reference image buffer 4 is set to the delayed image buffer in t−m−1, and the mode of (current bird's-eye image−delayed bird's-eye image) is established as the obstacle detection mode. In this case, a captured image obtained in an immediately preceding image pickup cycle T−1 is always stored into the current image buffer 2 at the beginning of each image pickup cycle T.

Then, after a stop of the vehicle is detected in an image pickup cycle t−n+1, in an immediately subsequent image pickup cycle t−n+2, information on vehicle displacement that represents the amount of change in the position and orientation of the vehicle from an image pickup cycle t−n immediately before the stop of the vehicle to an image pickup cycle t−n+1 immediately after the stop, is stored as the stopping displacement information.

Also in the immediately subsequent image pickup cycle t−n+2, the first reference image buffer 4 is specified to the fixed image buffer, while the second reference image buffer 5 is specified to the delayed image buffer, and the mode of {(current bird's-eye image−delayed bird's-eye image)+(current bird's-eye image−fixed bird's-eye image)} is established as the obstacle detection mode. These settings are activated from the beginning of a next subsequent image pickup cycle t−n+3.

Therefore, the first reference image buffer 4 functions as the delayed image buffer in the image pickup cycles from t−m−1 to t−n+2, and, at the beginning of each image pickup cycle T, a bird's-eye image obtained by viewpoint conversion of the captured image, which has been photographed two cycles earlier than the image pickup cycle T, (e.g., photographed in an image pickup cycle T−2), is stored as the delayed bird's-eye image into the first reference image buffer 4, which functions as the delayed image buffer.

Moreover, in the image pickup cycles from t−m−1 to t−n+2, obstacle detection is performed in the detection mode of (current bird's-eye image−delayed bird's-eye image).

Next, the first reference image buffer 4 functions as the fixed image buffer from and after the beginning of the image pickup cycle t−n+3, and continuously retains, as a fixed bird's-eye image, the delayed bird's-eye, which has been obtained by viewpoint conversion of a captured image photographed in the image pickup cycle t−n and stored in the image pickup cycle t−n+2 immediately before the first reference image buffer 4 is specified to the fixed image buffer, i.e. the delayed bird's-eye image obtained immediately prior to the time of the vehicle stop, until the first reference image buffer 4 is specified to the delayed image buffer again.

On the other hand, the second reference image buffer 5 functions as the delayed image buffer from and after the image pickup cycle t−n+3, and, at the beginning of each image pickup cycle T before the second reference image buffer 5 is specified to the fixed image buffer again, the bird's-eye image obtained by viewpoint conversion of the captured image photographed two cycles earlier than the image pickup cycle T, i.e. photographed in the image pickup cycle T−2 is stored as the delayed bird's-eye image in the second reference image buffer 5.

Next, when the when the start of travel of the vehicle is detected in the image pickup cycle t+2, the mode of (current bird's-eye image−delayed bird's-eye image) is established as the obstacle detection mode at a subsequent image pickup cycle t+3, and activated from the beginning of a next subsequent image pickup cycle t+4. While the vehicle is traveling, the bird's-eye image obtained by viewpoint conversion of the captured image in the image pickup cycle immediately before the cycle of the captured image stored in the current image buffer 2 is inserted as the delayed bird's-eye image into the delayed image buffer for each image pickup cycle, and obstacle detection is performed in the detection mode of (current bird's-eye image−delayed bird's-eye image).

While the vehicle is stopping, the bird's-eye image obtained by viewpoint conversion of the captured image in the image pickup cycle immediately before the cycle of the captured image stored in the current image buffer 2 is inserted as the delayed bird's-eye image into the delayed image buffer, while the bird's-eye image obtained by viewpoint conversion of the captured image in the image pickup cycle immediately before the stop of the vehicle is inserted as the fixed bird's-eye image into the fixed image buffer for each image pickup cycle, and obstacle detection is performed in the detection mode of {(current bird's-eye image−delayed bird's-eye image)+(current bird's-eye image−fixed bird's-eye image)}.

Next, obstacle detecting operation performed as described above in the detection mode of (current bird's-eye image−delayed bird's-eye image) while the vehicle is traveling, and in the detection mode of {(current bird's-eye image−delayed bird's-eye image)+(current bird's-eye image−fixed bird's-eye image)} while the vehicle is stopped will be described below.

Firstly, the obstacle detecting operation in the detection mode of (current bird's-eye image−delayed bird's-eye image) while the vehicle is traveling is described.

Here, detecting operation in the image pickup cycle t−m+1 shown in FIG. 3 is described as one example of the obstacle detecting operation performed while the vehicle is traveling in the following explanation.

In this example, the current image buffer 2 outputs, at the image pickup cycle t−m+1, the captured image in an image pickup cycle t−m as the current captured image. Then, the viewpoint conversion unit 3 performs viewpoint conversion of the current captured image, which is input from the current image buffer 2 to generate, as the current bird's-eye image, the bird's-eye image representing the rear of the vehicle viewed from above, and outputs the generated current bird's-eye image to the differential image generation unit 8.

On the other hand, the reference image buffer specified as the delayed image buffer at the image pickup cycle t−m+1 (the first reference image buffer 4 in this example) outputs as the delayed bird's-eye view the bird's-eye view obtained by viewpoint conversion of the captured image, which is captured in the image pickup cycle t−m and stored in the reference buffer, to the selector 6.

When the detection mode of (current bird's-eye image−delayed bird's-eye image) is established, the selector 6 outputs only the delayed bird's-eye image output from the reference image buffer specified as the delayed image buffer (the first reference image buffer 4 in this example) to the projective transformation unit 7.

Here, the processor 12, which determines, for each image pickup cycle, the amount of change in the position and orientation of the vehicle attained after the previous determination as information on vehicle displacement based on the vehicle speed, the steering angle, or the angular velocity detected by the vehicle state sensor 13 as described above, outputs the information on vehicle displacement determined for each image pickup cycle to the projective transformation unit 7.

Then, when the detection mode of (current bird's-eye image−delayed bird's-eye image) is established, the projective transformation unit 7 performs projective transformation of the delayed bird's-eye image, which is input from the selector 6, and outputs the transformed image to the differential image generation unit 8. Here, the projective transformation of the delayed bird's-eye image is achieved by projectively transforming the delayed bird's-eye image based on the information on vehicle displacement input from the processor 12 in such a manner that the same pixel coordinates are assigned to both pixels of the delayed bird's-eye image and pixels of the current bird's-eye image, which is input from the viewpoint conversion unit 3, in which the same location on the ground in the rear of the vehicle is photographed when the ground in the rear of the vehicle is flat.

It is noted, however, that the delayed bird's-eye image may be projectively transformed with reference to the current bird's-eye image in such a manner that a characteristic pattern on the delayed bird's-eye image has coordinates identical to those of a characteristic pattern, corresponding to the characteristic pattern on the delayed bird's-eye image, on the current bird's-eye image which is presently output from the viewpoint conversion unit 3.

Then, the differential image generation unit 8 finds a difference between portions of the current bird's-eye image input from the viewpoint conversion unit 3 and the projectively transformed delayed bird's-eye image output from the projective transformation unit 7 where their coordinate ranges overlap each other, and outputs the difference as a differential image to the obstacle detection unit 9. In this regard, however, edges contained in each of the images may be extracted to generate edge images respectively for the projectively transformed delayed bird's-eye image and the current bird's-eye image, and a difference between the generated edge images may be output as the differential image.

Then, the obstacle detection unit 9 detects the presence of an obstacle when the differential image output from the differential image generation unit 8 indicates that there is a difference between the current bird's-eye image input from the viewpoint conversion unit 3 and the projectively transformed delayed bird's-eye image output from the projective transformation unit 7. In addition, upon detection of the presence of the obstacle, the obstacle detection unit 9 provides a notification notifying the presence of a detected obstacle to the warning tone output unit 14, and locates from the differential image output from the differential image generation unit 8 a region of the current bird's-eye image in which there is the difference between the current bird's-eye image and the projectively transformed delayed bird's-eye image, and outputs the located region as an obstacle photographed region to the obstacle displaying image generation unit 10.

Then, upon receipt of the notification notifying the presence of the detected obstacle, the warning tone output unit 14 outputs a predetermined warning tone from a speaker. Further, the obstacle displaying image generation unit 10 determines, by means of inverse viewpoint conversion or the like, a region of the current captured image input from the current image buffer 2 corresponding to the obstacle photographed region located by the obstacle detection unit 9 as an obstacle detected region. It then generates an obstacle displaying image in which the determined obstacle detected region is represented on the current captured image, and displays the obstacle displaying image on the display apparatus 11. However, after correcting the current captured image for distortion due to the wide-angle lens of the rear camera 1, an image in which the obstacle detected region is represented on the corrected current captured image may be displayed as the obstacle displaying image.

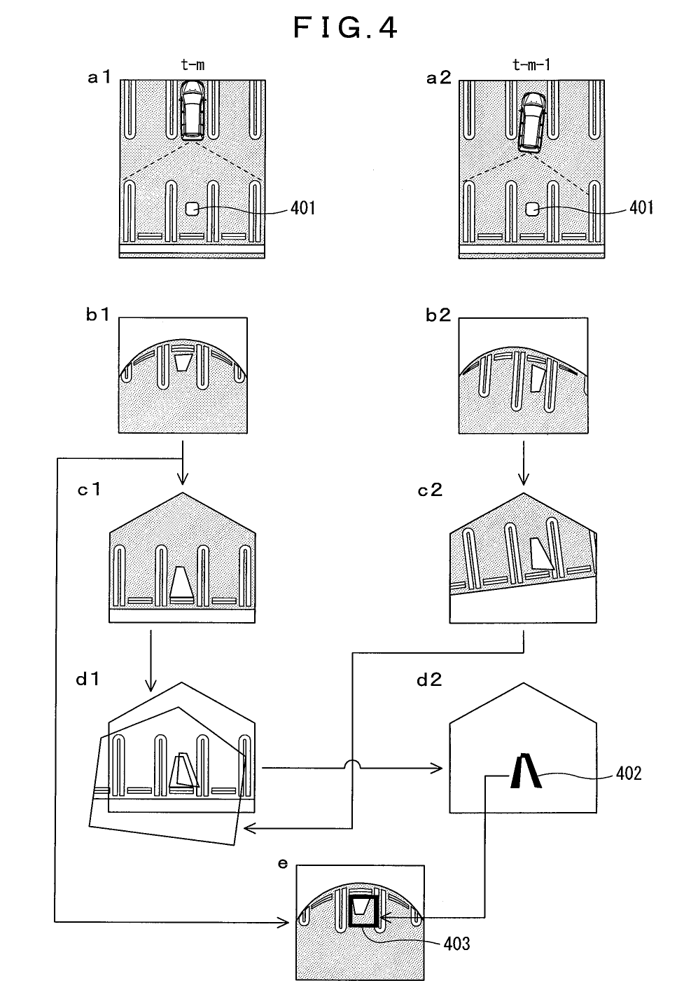

An example of obstacle detection performed with the detection mode of (current bird's-eye image−delayed bird's-eye image) in the image pickup cycle t−m+1 during traveling is shown in FIG. 4. Now, it is assumed that the vehicle moves as indicated from (a2) to (a1) for a duration from an image pickup cycle t−m−1 to an image pickup cycle t−m. It is also assumed that, in a time period including the image pickup cycles t−m−1 and t−m, there is a three-dimensional object or obstacle 401 in the rear of the vehicle.

In this example, a captured image obtained in the image pickup cycle t−m represents an image as shown in (b1), and a captured image obtained in the immediately preceding image pickup cycle t−m−1 represents an image as shown in (b2).

Then, in a subsequent image pickup cycle t−m+1, the captured image (b1) obtained in the image pickup cycle t−m is output as a current image from the current image buffer 2, and is converted into the current bird's-eye image by the viewpoint conversion unit 3 as shown in (c1), and output to the differential image generation unit 8.

Further, a delayed bird's-eye image shown in (c2) obtained by viewpoint conversion of the image of (b2) captured in the image pickup cycle t−m−1 is output from the reference image buffer, which is specified as the delayed image buffer to the projective transformation unit 7. Then, the delayed bird's-eye image shown in (c2) is projectively transformed, as shown in (d1) by the projective transformation unit 7, and output to the differential image generation unit 8 in which the difference between the projectively transformed delayed bird's-eye image and the current bird's-eye image of (c1) is determined, to thereby generate a differential image shown in (d2). Following this, detection of an obstacle and calculation of a region 402 where the obstacle exists are performed based on the differential image shown in (d2) by the obstacle detection unit 9.

Then, the predetermined warning tone is output from the speaker by the warning tone output unit 14. In addition, an image in which a rectangular box 403 for indicating the obstacle detected region calculated from the region 402 where the obstacle exists is placed as shown in (e) on the current captured image is displayed.

Here, because the obstacle 401 of the three-dimensional object is imaged in different shapes on the bird's-eye images (c1) and (c2), which are respectively generated by viewpoint conversion of the captured images obtained at different positions, the obstacle can be properly detected, as indicated by the rectangular box 403 of (e) on the current captured image, and can be presented to a user. It should be noted that, similarly to the obstacle 401 of the three-dimensional object, a moving obstacle can be also detected and presented according to the above-described process.

Next, obstacle detecting operation in the detection mode of {(current bird's-eye image−delayed bird's-eye image)+(current bird's-eye image−fixed bird's-eye image)} while the vehicle is stopping, will be described. Here, detecting operation in the image pickup cycle t+1 shown in FIG. 3 is described as one example of the obstacle detecting operation performed while the vehicle is stopping.

In this example, the current image buffer 2 outputs, at the image pickup cycle t+1, the captured image in an image pickup cycle t as the current captured image. The viewpoint conversion unit 3 performs viewpoint conversion of the current captured image, which is input from the current image buffer 2, to generate, as the current bird's-eye image, the bird's-eye image representing the rear of the vehicle viewed from above, and outputs the current bird's-eye image to the differential image generation unit 8.

The reference image buffer specified as the delayed image buffer in the image pickup cycle t+1 (the second reference image buffer 5 in this example) outputs as the delayed bird's-eye image, the bird's-eye image obtained by viewpoint conversion of the captured image, which is captured in the image pickup cycle t−1 and stored in the reference image buffer, to the selector 6.

Further, the reference image buffer specified as the fixed image buffer in the image pickup cycle t+1 (the first reference image buffer 4 in this example) outputs, as the fixed bird's-eye image, the bird's-eye image obtained by viewpoint conversion of the captured image, which has been captured in the image pickup cycle t−n immediately before the vehicle is stopped, and stored in the reference image buffer, to the selector 6.

When the detection mode of {(current bird's-eye image−delayed bird's-eye image)+(current bird's-eye image−fixed bird's-eye image)} is established, the selector 6 sequentially outputs both of the input delayed bird's-eye image and fixed bird's-eye image to the projective transformation unit 7.

When the detection mode of {(current bird's-eye image−delayed bird's-eye image)+(current bird's-eye image−fixed bird's-eye image)} is established, the projective transformation unit 7 outputs the input delayed bird's-eye image to the differential image generation unit 8 without processing, but performs projective transformation of the fixed bird's-eye image, and outputs the projectively transformed fixed bird's-eye image to the differential image generation unit 8.

Here, the projective transformation of the fixed bird's-eye image is achieved by projectively transforming the fixed bird's-eye image based on the stopping vehicle displacement information stored in the processor 12 in such a manner that the same pixel coordinates are assigned to both the pixels of the fixed bird's-eye image and the pixels of the current bird's-eye image input from the viewpoint conversion unit 3 in which the same location on the ground in the rear of the vehicle is photographed when the ground in the rear of the vehicle is flat.

It is noted, however, that the fixed bird's-eye image may be projectively transformed with reference to the current bird's-eye image in such a manner that a characteristic pattern on the fixed bird's-eye image has coordinates identical to those of a characteristic pattern, corresponding to the pattern on the fixed bird's-eye image, on the current bird's-eye image which is presently output from the viewpoint conversion unit 3.

When the detection mode of {(current bird's-eye image−delayed bird's-eye image)+(current bird's-eye image−fixed bird's-eye image)} is established, the differential image generation unit 8 finds a difference between portions of the current bird's-eye image and the delayed bird's-eye image output from the projective transformation unit 7 where their coordinate ranges overlap each other, and outputs the difference as a first differential image to the obstacle detection unit 9. In this regard, however, edges contained in each of the images may be extracted to generate edge images respectively for the delayed bird's-eye image and the current bird's-eye image, and a difference between the generated edge images may be output as the first differential image.

In addition, the differential image generation unit 8 further finds a difference between portions of the current bird's-eye image input from the viewpoint conversion unit 3 and the projectively transformed fixed bird's-eye image output from the projective transformation unit 7, where their coordinate ranges overlap each other, and outputs the difference as a second differential image to the obstacle detection unit 9. In this regard, however, the edges contained in each of the images may be extracted to respectively generate the edge images for the projectively transformed fixed bird's-eye image and the current bird's-eye image, and a difference between the generated edge images may be output as the second differential image.

Then, the obstacle detection unit 9 detects the presence of an obstacle when the first differential image output from the differential image generation unit 8 indicates that there is a difference between the current bird's-eye image input from the viewpoint conversion unit 3 and the projectively transformed delayed bird's-eye image output from the projective transformation unit 7, or when the second differential image output from the differential image generation unit 8 indicates that there is a difference between the current bird's-eye image output from the viewpoint conversion unit 3 and the projectively transformed fixed bird's-eye image output from the projective transformation unit 7.

In addition, the obstacle detection unit 9 provides the notification notifying the presence of a detected obstacle to the warning tone output unit 14. When the detection mode of {(current bird's-eye image−delayed bird's-eye image)+(current bird's-eye image−fixed bird's-eye image) is established, the obstacle detection unit 9 locates from the first differential image output from the differential image generation unit 8, a region of the current bird's-eye image in which there is a difference between the current bird's-eye image and the projectively transformed delayed bird's-eye image, and also locates from the second differential image output from the differential image generation unit 8, a region of the current bird's-eye image in which there is a difference between the current bird's-eye image and the projectively transformed delayed bird's-eye image. The obstacle detection unit 9 then outputs each of the located regions as an obstacle photographed region to the obstacle displaying image generation unit 10.

Then, upon receipt of the notification notifying the presence of the detected obstacle, the warning tone output unit 14 outputs the predetermined warning tone from the speaker. Further, the obstacle displaying image generation unit 10 determines, by means of inverse viewpoint conversion or the like, a region of the current captured image input from the current image buffer 2 corresponding to each of the obstacle photographed region as an obstacle detected region, generates an obstacle displaying image in which the determined obstacle detected region is represented on the current captured image, and displays the obstacle displaying image on the display apparatus 11. However, after correcting the current captured image for distortion due to the wide-angle lens of the rear camera 1, an image in which the obstacle detected region is represented on the corrected current captured image may be displayed as the obstacle displaying image.

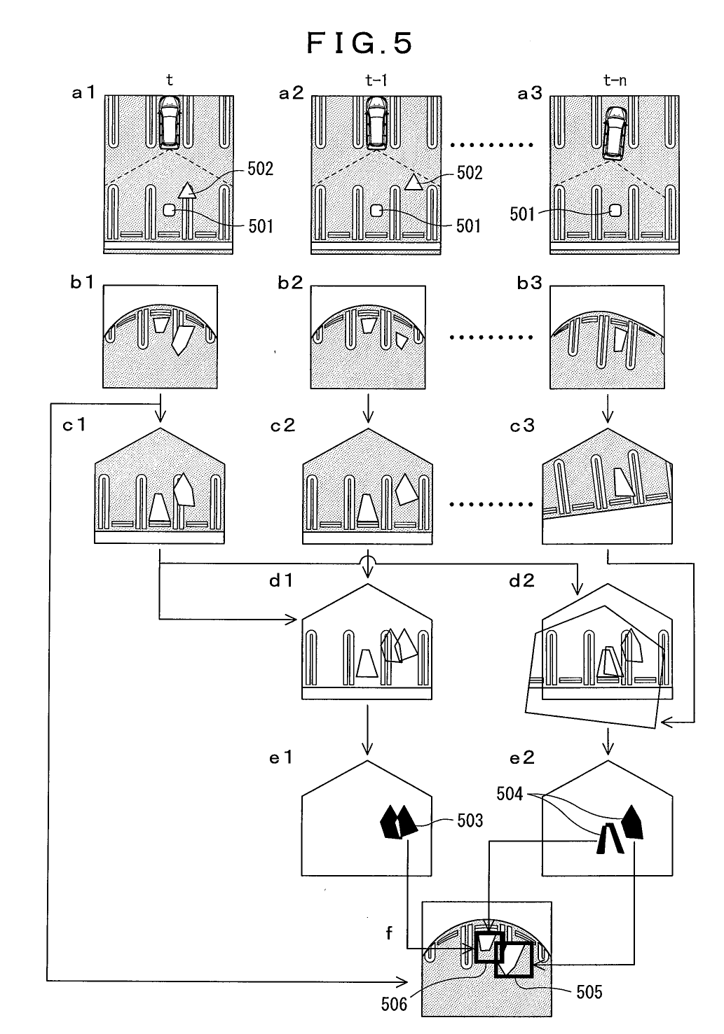

Here, an example of obstacle detection performed with the detection mode of {(current bird's-eye image−delayed bird's-eye image)+(current bird's-eye image−fixed bird's-eye image)} in the image pickup cycle t+1 during a stop of the vehicle is shown in FIG. 5. FIG. 5 shows that the vehicle is located at a position (a3) in an image pickup cycle t−n immediately before the vehicle is stopped, that the vehicle is located at a position (a2) in an image pickup cycle t−1 in which the vehicle is stopping, and at a position (a1) in a immediately subsequent image pickup cycle t in which the vehicle is stopping. In addition, FIG. 5 shows that an obstacle 501 (a three-dimensional object) exists near the rear of the vehicle in a time period including the image pickup cycles t−n, t−1, and t, and a moving obstacle 502 exists near the rear of the vehicle during a time period including the image pickup cycles t−1 and t.

In this example, a captured image obtained in the image pickup cycle t represents an image shown in (b1), a captured image obtained in the immediately preceding image pickup cycle t−1 represents an image shown in (b2), and a captured image obtained in the further preceding image pickup cycle t−n immediately before the stop of the vehicle represents an image shown in (b3).

In a subsequent image pickup cycle t+1, the captured image (b1) obtained in the image pickup cycle t is output as a current image from the current image buffer 2, and converted into a current bird's-eye image by the viewpoint conversion unit 3 as shown in (c1), and the output to the differential image generation unit 8.

Further, a delayed bird's-eye image shown in (c2) obtained by viewpoint conversion of the image of (b2) captured in the image pickup cycle t−1 is output from the reference image buffer, which is specified as the delayed image buffer to the projective transformation unit 7 from which the delayed bird's-eye image is output without being processed to the differential image generation unit 8.

Next, a difference between the delayed bird's-eye image shown in (c2) and the current bird's-eye image shown in (c1) is determined, to generate a first differential image shown in (d1). Following this, detection of obstacles and calculation of regions 503 where the obstacles exist, is performed based on the first differential image shown in (d2) by the obstacle detection unit 9, as illustrated in (e1).

A fixed bird's-eye image shown in (c3) obtained by viewpoint conversion of the image of (b3) captured in the image pickup cycle t−n is output from the reference image buffer, which is specified as the fixed image buffer to the projective transformation unit 7. Then, in the projective transformation unit 7, the fixed bird's-eye image shown in (c3) is projectively transformed, as shown in (d2), and output to the differential image generation unit 8.

In the differential image generation unit 8, a difference between the projectively transformed fixed bird's-eye image and the current bird's-eye image of (c1) is determined, to thereby generate a second differential image shown in (d2). Following this, detection of obstacles and calculation of regions 504 where the obstacles exist are performed based on the differential image of (d2) by the obstacle detection unit 9, as illustrated in (e2).

Next, the predetermined warning tone is output from the speaker by the warning tone output unit 14. In addition, an image in which rectangle boxes 505 and 506 for indicating the obstacle as shown in (f) on the current captured image, is displayed as the obstacle displaying image on the display apparatus 11 by the obstacle displaying image generation unit 10.

Here, because the moving obstacle 502 is imaged, as shown in (c1) and (c2), in different shapes at different positions on the bird's-eye images which are obtained at different points in time, the region 503 where the obstacle exists can be determined from the current bird's-eye image and the delayed bird's-eye image. As a result, the obstacle can be properly detected at the position where the obstacle 502 is photographed or in the vicinity of the position as indicated by the rectangular box 505 of (f), and can be presented to the user.

On the other hand, the obstacle 501 being the three-dimensional object is imaged in different shapes on the bird's-eye images (c1) and (c3), which are respectively generated by viewpoint conversion of the captured images obtained at different positions. Therefore, after the bird's-eye image obtained by viewpoint conversion of the captured image, which is captured at a location different from a vehicle stopped position immediately before the vehicle is stopped, is retained as the fixed bird's-eye image. The region 504 where the obstacle exits can be determined from the difference between the retained fixed bird's-eye image and the current bird's-eye image, which is captured at the vehicle stopped position. As a result, the obstacle can be properly detected at the position where the obstacle 501 of the three-dimensional object or in the vicinity of the position as indicated by the rectangle box 506 of (f) on the current captured image, and can be presented to the user.

It should be noted that although this embodiment has been described with reference to the example in which the rear camera 1 is provided to detect the object in the rear of the vehicle, this embodiment is not limited to the example, and may be similarly applied to detection of an obstacle in an arbitrarily specified direction, such as a case where a front camera or a side camera is equipped to detect an obstacle in the front or side of a vehicle.

Further, in the above-describe embodiment, a differential image between the current bird's-eye image input from the viewpoint conversion unit 3 and the projectively transformed delayed bird's-eye image output from the projective transformation unit 7, the differential image which has been output from the differential image generation unit 8 upon detection of a stop of the vehicle by the obstacle detection unit 9 may be stored as a third differential image, and detection of the presence of an obstacle and notification of the detection to the warning tone output unit 14, or calculation of the region where the obstacle is photographed and notification of the region to the obstacle displaying image generation unit 10, may be performed also based on the third differential image in addition to the first and second differential images until travel of the vehicle is started again.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A periphery monitoring apparatus for a vehicle, comprising:
a camera for capturing images of a periphery of the vehicle;
a traveling/not-traveling detection unit for detecting whether the vehicle is traveling or is stopping;
an image storage unit configured to store, when the vehicle stops, an image the vehicle prior to the stopping of the vehicle, the image stored as a pre-stop image, and
an obstacle detection unit that detects an obstacle on the periphery of the vehicle based on a difference between a current image captured by the camera and the pre-stop image during a time period in which the traveling/not-traveling detection unit detects that the vehicle is stopping.

2. The periphery monitoring apparatus according to claim 1, wherein:
the obstacle detection unit detects, during the time period in which the traveling/not-traveling detection unit detects that the vehicle is stopping, the obstacle on the periphery of the vehicle based on a difference between the current image and an image captured prior to the current image, and based on the difference between the current image and the pre-stop image.

3. The periphery monitoring apparatus according to claim 2, wherein:
the obstacle detection unit detects, during a time period in which the traveling/not-traveling detection unit detects that the vehicle is traveling, the obstacle on the periphery of the vehicle based on the difference between the current image and the image captured prior to the current image.

4. The periphery monitoring apparatus according to claim 1, wherein:
the obstacle detection unit detects, during a time period in which the traveling/not-traveling detection unit detects that the vehicle is traveling, the obstacle on the periphery of the vehicle based on the difference between the current image and an image captured prior to the current image.

5. The periphery monitoring apparatus according to claim 1, further comprising:
a viewpoint conversion unit configured to convert the image captured by the camera into a bird's-eye image representing the periphery of the vehicle in a state observed from above, wherein;
the image storage unit stores, as the pre-stop image, the bird's-eye image when the stop of the vehicle is found; and
the obstacle detection unit detects, during the time period in which the traveling/not-traveling detection unit detects that the vehicle is stopping, the obstacle on the periphery of the vehicle based on a difference between image portions corresponding to a same captured region in a latest bird's-eye image and in the pre-stop image.

6. The periphery monitoring apparatus according to claim 5, wherein:
the obstacle detection unit detects, during the time period in which the traveling/not-traveling detection unit detects that the vehicle is stopping, the obstacle on the periphery of the vehicle based on a difference between the latest bird's-eye image and a bird's-eye image generated prior to the latest bird's-eye image, and based on a difference between the image portions corresponding to the same captured region in the latest bird's-eye image and in the pre-stop image.

7. The periphery monitoring apparatus according to claim 5, wherein:
the obstacle detection unit detects, during a time period in which the traveling/not-traveling detection unit detects that the vehicle is traveling, the obstacle on the periphery of the vehicle based only on the difference between the latest bird's-eye image and the bird's-eye image generated prior to the latest bird's-eye image.

8. An obstacle detection method for detecting an obstacle near a vehicle comprising the steps of:
a capturing step in which a periphery of the vehicle is captured by a camera;
a traveling/not-traveling detecting step for detecting whether the vehicle is traveling or stopping;
an image storing step in which when the vehicle stops, an image of the vehicle prior to stopping is captured and stored as a pre-stop image; and
an obstacle detecting step for detecting, during a time period in which it is detected that the vehicle is stopping, the obstacle on the periphery of the vehicle based on a difference between a current image and the stored pre-stop image.

9. The obstacle detection method according to claim 8, wherein:
the obstacle detecting step further comprises detecting, during the time period in which it is detected that the vehicle is stopping, the obstacle on the periphery of the vehicle based on a difference between the current image and an image captured prior to the current image, and based on the difference between the current image and the stored pre-stop image.

10. The obstacle detection method according to claim 9, wherein:
the obstacle detecting step further comprises detecting, during a time period in which it is detected that the vehicle is traveling, the obstacle on the periphery of the vehicle based on the difference between the current image and the image captured prior to the current image.

11. The obstacle detection method according to claim 8, wherein:
the obstacle detecting step further comprises detecting, during a time period in which it is detected that the vehicle is traveling, the obstacle on the periphery of the vehicle based on a difference between the current image and an image captured prior to the current image.

12. The obstacle detection method according to claim 8, further comprising:
a viewpoint converting step in which the image captured by the camera is converted into a bird's-eye image representing the periphery of the vehicle in a state observed from above;
wherein in the image storing step, when a stop of the vehicle is found, the bird's-eye image is stored as the pre-stop image; and
in the obstacle detecting step, during the time period in which it is detected that the vehicle is stopping, the obstacle on the periphery of the vehicle is detected based on a difference between image portions corresponding to a same captured region in a latest bird's-eye image and in the stored pre-stop image.

13. The obstacle detection method according to claim 12, wherein:
the obstacle detecting step comprises detecting, during the time period in which it is detected that the vehicle is stopping, the obstacle on the periphery of the vehicle based on a difference between the latest bird's-eye image and a bird's-eye image generated prior to the latest bird's-eye image, and based on the difference between the image portions corresponding to the same captured region in the latest bird's-eye image and in the stored pre-stop image.

14. The obstacle detection method according to claim 12, wherein:
the obstacle detecting step comprises detecting, during the time period in which it is detected that the vehicle is traveling, the obstacle on the periphery of the vehicle based on the difference between the latest bird's-eye image and the bird's-eye image generated prior to the latest bird's-eye image.

15. A computer-readable medium having computer-readable content representing a computer program for a vehicle capture system having a vehicle camera configured to capture a periphery of a vehicle, the computer program causing the computer to perform that acts of:
providing a traveling/not-traveling detection unit for detecting whether the vehicle is traveling or stopping;
providing an image storage unit in which when a stop of the vehicle is detected, an image captured before the vehicle is stopped is stored as a pre-stop image; and
providing an obstacle detection unit for detecting, during a time period in which the traveling/not-traveling detection unit detects that the vehicle is stopping, an obstacle on the periphery of the vehicle based on a difference between a current image and the pre-stop image.

16. The computer-readable medium according to claim 15, wherein:
the obstacle detection unit detects, during the time period in which the traveling/not-traveling detection unit detects that the vehicle is stopping, the obstacle on the periphery of the vehicle based on a difference between the current image and an image captured prior to the current image, and based on the difference between the current image and the pre-stop image.

17. The computer-readable medium according to claim 16, wherein:
the obstacle detection unit detects, during a time period in which the traveling/not-traveling detection unit detects that the vehicle is traveling, the obstacle on the periphery of the vehicle based on the difference between the current image and the image captured prior to the current image.

18. The computer-readable medium according to claim 15, wherein:
the obstacle detection unit detects, during a time period in which the traveling/not-traveling detection unit detects that the vehicle is traveling, the obstacle on the periphery of the vehicle based on a difference between the current image and an image captured prior to the current image.

19. The computer-readable medium according to claim 15, comprising:
providing a viewpoint conversion unit configured to convert the image captured by the camera into a bird's-eye image representing the periphery of the vehicle in a state observed from above; wherein
the image storage unit stores, as the pre-stop image, the bird's-eye image when the stop of the vehicle is found, and
the obstacle detection unit detects, during the time period in which the traveling/not-traveling detection unit detects that the vehicle is stopping, the obstacle on the periphery of the vehicle based on a difference between image portions corresponding to a same captured region in a latest bird's-eye image of the current image and the pre-stop image.

20. The computer-readable medium according to claim 19, wherein:
the obstacle detection unit detects, during the time period in which the traveling/not-traveling detection unit detects that the vehicle is stopping, the obstacle on the periphery of the vehicle based on a difference between the latest bird's-eye image and a bird's-eye image generated prior to the latest bird's-eye image, and based on the difference between the image portions corresponding to the same captured region in the latest bird's-eye image and the pre-stop image.
